(19) United States
(12) Patent Application Publication
(10) Pub. No.: US 2010/0177921 A1
(43) Pub. Date: Jul. 15, 2010

(54) RESPONSE SPEAKER SYSTEM

(76) Inventor: Richard Bos, Saratoga Springs, UT (US)

Correspondence Address: HOLME ROBERTS & OWEN, LLP, 299 SOUTH MAIN, SUITE 1800, SALT LAKE CITY, UT, 84111, US

(21) Appl. No.: 12/353,919

(22) Filed: Jan. 14, 2009

(51) Int. Cl. H04R 1/02; H04R 25/00

(52) U.S. Cl. 381/351; 381/182

(57) ABSTRACT

A sound generator like a guitar supplies an electrical out put to operate speakers that are mounted in a chassis. The electrical output is divided into three frequency ranges, separately amplified and delivered to speakers mounted in a three separate enclosures each acoustically isolated from the other.

### BACKGROUND OF THE INVENTION

1. The Field of the Invention

This invention relates to audio speaker systems for use with instruments that supply an electrical signal reflective of sound for conversion to sound and more particularly to speaker systems having multiple speakers all in a single chassis and even more particularly to speaker systems having multiple speakers for use with instruments that supply a signal reflective of a bass sound as an input.

2. The Relevant Technology

Speaker devices configured to transmit audible sound are known to be constructed in various configurations. All speaker devices have some form of transducing device typically mounted in a chassis. The transducing device is configured to convert electrical impulses reflective of audible sound into corresponding mechanical sound waves in a manner that is well known in the art. As an example, the transducing device typically includes an electromagnet mounted to receive modulated electrical impulses and vibrate a cone made from a fiber material; and the vibration of the cone moves the surrounding air to create the desired sound. The transducing device is typically referred to as a speaker, and the combination of the transducing device or devices mounted in a chassis of is also typically referred to as a speaker. Thus, the word “speaker” can have multiple meanings; and the intended meaning is best ascertained from the context.

Speaker systems are also known to include multiple speakers some of which are selected to broadcast in particular frequency ranges. That is, it is known that audible sound occurs primarily in a frequency range from about 20 cycles per second to about 20,000 cycles per second. Those skilled in the art will recognize that to get better quality sound, the speakers (transducing device) are typically constructed to produce sound in different ranges. Thus, transducing speakers can be constructed in a variety of ways to broadcast sound in different ranges which vary based on the transducing speaker, cost, space, audience, and the like. Some transducing speakers are referred to as a mid range, high frequency (HF), low frequency or bass and the like. The exact frequency range will vary based on a variety of factors. However, low frequency or bass speakers typically produce sound from about 40 to 60 cycles per second or hertz (Hz) to about 450 to 500 Hz.; mid range speakers produce sound from around 70 Hz to 100 Hz to about 3000 Hz, and HF speakers typically produce sound from around 3000 Hz to 3500 Hz to above 20,000 Hz. In other words, while the frequency range for bass, mid range and HF differ, they may and typically do overlap.

Speaker devices that include a chassis with one or more transducing devices have been known for years. For example, U.S. Pat. No. 3,443,669 (Virva, et al.) discloses a mid range speaker enclosed in a cardboard housing to isolate it from nearby acoustic energy. U.S. Pat. No. 4,031,318 (Pitre) discloses a speaker system configured to broadcast in more than one direction and over the full audio range. U.S. Pat. No. 4,799,264 (Plummer) shows a speaker with a filter for intercepting and reradiating sound involving slots formed in the chassis or housing. A midrange loudspeaker is formed using vibrating elements with diffusers is shown in U.S. Pat. No. 5,131,052 (Hill, et al.). U.S. Pat. No. 5,147,986 (Cockrum, et al.) discloses a subwoofer speaker in which the chassis is formed into three chambers that are acoustically coupled with each other using ports.

Musical instruments like electrical guitars, electrical keyboards, electrical reed instruments, and the like generate an electrical signal reflective of a particular sound. The electrical signal is typically processed by some form of amplifier and possibly other sound processing devices. The electrical signal is supplied to a speaker system that includes circuits for amplification and division providing output signals that are delivered to transducing speakers configured to broadcast in different frequency ranges such as HF, mid range and bass. Speaker systems having transducing speakers in different speaker ranges in a single chassis to produce crisp and clean sound are not known.

### BRIEF SUMMARY OF THE INVENTION

A speaker system has a chassis having a face. The chassis includes a first compartment having a first side that is a portion of the face and a second compartment with a face that is a portion of the face of the chassis, the second compartment being acoustically isolated from the first compartment. Each compartment has a speaker for creating sound in a different speaker range; and each compartment is acoustically isolated one from the other. Preferably the speaker system has a third compartment to contain a speaker in a third frequency range. It too is acoustically isolated from the other two chambers. In preferred arrangements, the chambers are hermetically sealed, one from the other. The acoustically isolated chambers eliminate interference between speakers and in turn lead to the production of sound that is cleaner and crisper.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only what are presently regarded as preferred embodiments of the invention and are therefore not to be considered limiting of the scope as set forth in the appended claims hereto. In the drawings:

FIG. 1 is a depiction of a sound generating system of the present invention;

FIG. 2 is a perspective exploded view of a chassis for use with the sound generating system of the present invention;

FIG. 2A is a perspective exploded view of a chassis including a fourth compartment for use with the sound generating system of the present invention;

FIG. 3 is circuit diagram of a line filter suitable for use with the sound system of the present invention;

FIGS. 4 and 5 are circuit diagrams of a power supply components suitable for use with the sound system of the present invention;

FIGS. 6 and 7 are circuit diagrams of various circuits used to accomplish house keeping functions including interfacing functions suitable for use with the sound system of the present invention;

FIG. 8 is circuit diagram of an HF power amplifier suitable for use with the sound system of the present invention;

FIG. 9 is circuit diagram of an HF driver suitable for use with the sound system of the present invention;

FIG. 10 is circuit diagram of a low range or bass power amplifier suitable for use with the sound system of the present invention;

FIG. 11 is circuit diagram of a low range or bass driver suitable for use with the sound system of the present invention;

FIG. 12 is circuit diagram of a mid range power amplifier suitable for use with the sound system of the present invention; and

FIG. 13 is circuit diagram of a mid range driver suitable for use with the sound system of the present invention.

### DETAILED DESCRIPTION OF THE PREFERRED EMBODIMENTS

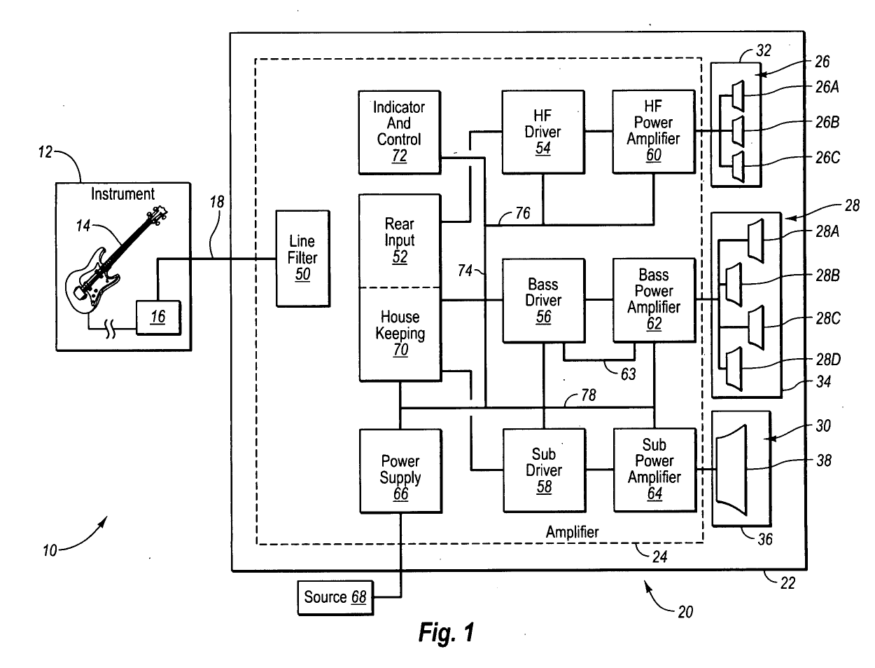

A sound generating system 10 is depicted in FIG. 1 to include means for generating desired sound. As presently contemplated, such means for generating sound includes any device capable of supplying an electrical signal reflective of sound that could include a radio, television, CD player, tape deck, or the like. As here depicted in FIG. 1, the means for generating sound is a sound generator 12 which can be and is contemplated to a musical instrument of the type that supplies an electrical signal as its output, like bass guitar 14. The sound generator 12 could also be other musical instruments including an electrical keyboard, certain reed instruments like a clarinet and saxophone, and other instruments including various kinds of other guitars and stringed instruments. Such instruments typically have an amplifier 16 associated with it which is operable to supply a suitable signal reflective of the desired sound at the output 18.

The output of the sound generator 12 is supplied to a speaker system 20 that includes a housing or chassis 22 that contains an amplifier 24 and, as here depicted, three speaker groups, 26, 28 and 30. While the present embodiment has three speaker groups, it should be understood that contemplated speaker systems may have only two and more than three speaker groups. The first speaker group 26 is shown to contain three separate HF speakers 26A, 26B and 26C as discussed in more detail hereinafter. Each of the speakers 26A, 26B and 26C are mounted in chamber or enclosure 32 that is acoustically separate and isolated from the other enclosures 34 and 36 containing the second speaker group 28 and the third speaker group 30.

The second speaker group 28 contains 4 mid range or bass speakers 28A-D which are also mounted in the enclosure 34. The third speaker group 30 is here shown as a single bass or sub bass speaker 38 mounted in the enclosure 36.

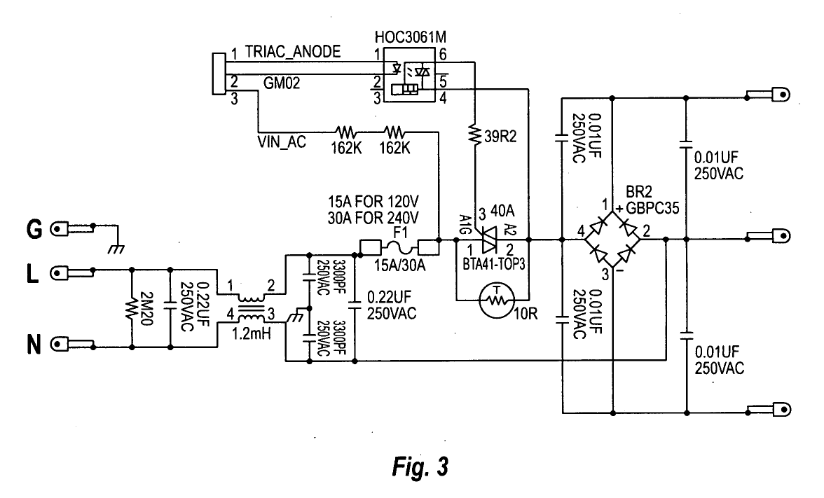

The amplifier 24 of the speaker system 20 receives an input that is the output 18 from the sound generator 12. The signal so received is filtered by a line filter 50 a detailed example of which is shown in FIG. 3. In one implementation, the line filter 50 is a radio frequency interference (RFI) filter that is located between the source (e.g., sound generator 12) and the power supply 66. The signal from the sound generator 12 is thereafter processed through rear input circuitry 52 for division into the HF, mid range (bass) and low range or sub bass frequency ranges. The divided signals are then further directed through suitable drivers 54, 56 and 58 which in turn supply their respective outputs to power amplifiers 60, 62 and 64. The power amplifiers 60, 62 and 64 then supply their the signals to their respective speaker groups 26, 28 and 30 as depicted in FIG. 1.

A feedback loop 63 may be implemented between the bass power amplifier 62 and the bass driver 56. Specifically, current sensing is picked up at power amplifier 62 and output back to driver 56 for amplification and processing. Driver 56 generates a variable negative output impedance that cancels out voice coil resistance from the speakers in speaker group 28. This allows changing the mass and the stiffness of the speaker group 28 through electrical means.

The amplifier 24 of FIG. 1 also contains a power supply 66 that receives power from an outside source 68 and converts it into the various power requirements of the various other components 54, 56, 58, 60, 62 and 64 as well as other housekeeping circuits 70 and control circuits 72 for indicators and other related functions via power conductors 74, 76 and 78.

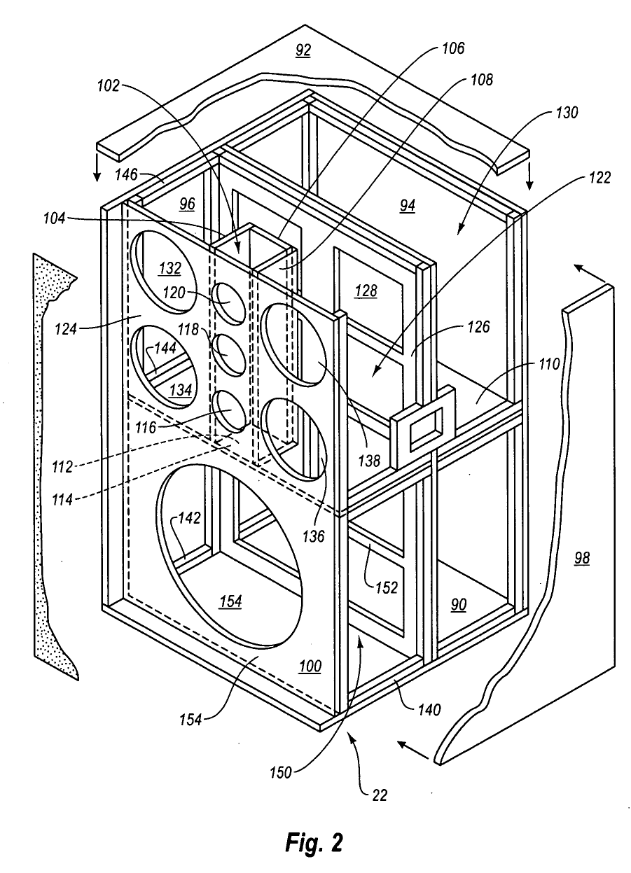

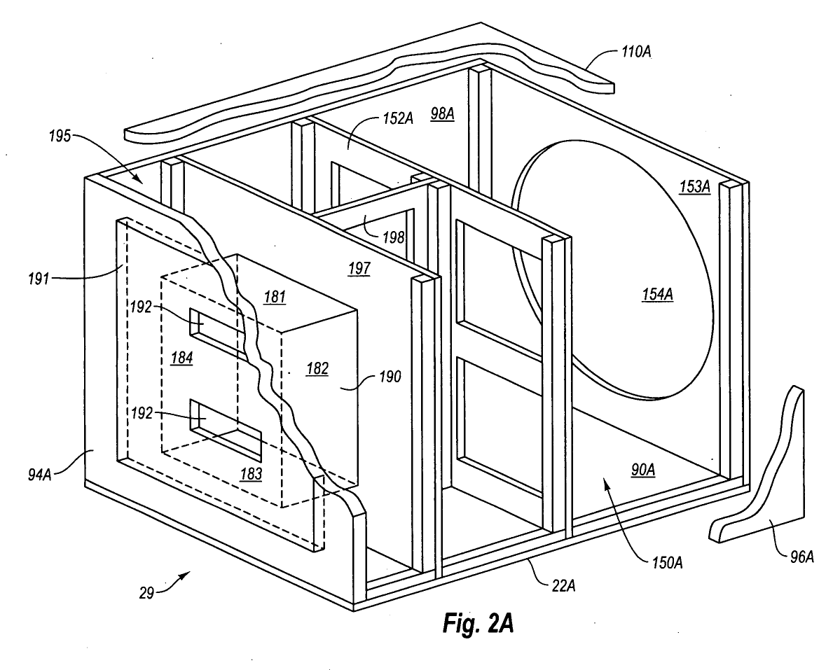

Turning to FIG. 2, chassis 22 of FIG. 1 is depicted in detail. The chassis 22 has a bottom 90, a top 92 (shown in cut-away), a rear 94, a side 96, a side 98 shown in cut-away and a face 100. As depicted, the rear 94, sides 96 and 98 and face 100 are assembled to form a four sided chassis that is square or rectangular in projection. However, it should be appreciated that the chassis 22 may be a wide variety of other geometric solid shapes that include, for example, cylinders, pyramids and obelisks, or a combination thereof. A decorative screen 109 is placed over face 100. The screen 109 is used for decoration as the screen is viewable from the front of the chassis 22. Also, screen 109 is used to and for prevent direct access to the speakers of the speaker groups 26, 28 and 30 of the speaker system 20 of FIG. 1, thereby protecting the speakers.

As depicted in FIG. 2, the chassis 22 is formed to have a first compartment or enclosure 102 that has sides 104, 106 and 108. The top 92 acts as the top of the enclosure 102 while a mid level divider 110 acts as the bottom 112 of the compartment 102. The compartment 102 also has a face 114 that is part of the face 100 of the chassis 22. Three apertures 116, 118 and 120 are formed in the face 114. The speakers 26A, 26B and 26C are positioned in the compartment 102 and mounted therein to transmit sound out of or through their respective apertures 116, 118, 120. Power to the speakers 26A, 26B and 26C, received from the HF power amplifier 60 (FIG. 1), is supplied through one of the sides 104, 106 and 108 with the surrounding hole sealed by a suitable potting compound not here shown to maintain clarity in the illustration.

The apertures 116, 118 and 120 are here shown to be circular and sized so that a suitable HF speaker, can be like speakers 26A-C, are mounted to register with the hole in a conventional manner. In preferred applications the circular apertures are less than about 6 inches in diameter (e.g., apertures 116, 118, and 120).

The first compartment 102 is mounted within the second compartment 122 that is formed by sides 96 and 98, the stiffener 126 and the upper portion or second compartment portion 124 of the face 100. The top 92 acts as the top of the second compartment 122, and the mid level divider 110 acts as the bottom of the second compartment 122. Stiffener 126 is positioned to provide structural strength to the chassis 22 and act as the rear of the second compartment 122. With the stiffener 126 being solid, the amplifier 24 of FIG. 1 may be optionally positioned behind compartment 122 in the upper rear compartment 130 between the stiffener 126 and the rear 94, with the rear 94 having suitable openings made to provide for wiring and controls. In another configuration, the amplifier may be positioned outside of the compartments or enclosures; and the stiffener 126 formed with a plurality of openings 128 to, among other things, reduce the weight of the chassis 22.

The upper portion 124 of the face 100 is formed with four apertures 132, 134, 136, 138. The bass speakers 28A-D (FIG. 1) are positioned within the second compartment 122 and mounted to register with the apertures 132, 134, 136 and 138 to transmit sound there through. The apertures 132, 134, 136 and 138 are each sized so the speaker fully registers with it and thus are sized to be from about 6 to about 12 inches in diameter (e.g., apertures 132, 134, 136, and 138) and preferably about 10 inches in diameter to receive suitably sized bass speakers.

It should be noted that the first compartment 102 and the second compartment 122 are acoustically isolated one from the other. As shown in FIG. 2, the compartments 102 and 122 are formed with no openings between them so that the sound reflected into each compartment 102 and 122 is not reflected into the other. The sound isolation can be further enhanced by fabricating the various components of the chassis 22 from a composite wood material and then gluing the various components together. Indeed, the chassis may be assembled using glue by itself and preferably using glue with screws or other suitable fasteners to provide a very rigid and rugged structure. Internal strips, like strips 140, 142, 144, 146, are used to facilitate assembly and provide for a sturdy structure while also allowing one to hermetically seal the first compartment 102 from the second compartment 122, and similarly seal the third compartment 150 from the first compartment 102 and the second compartment 122.

The third compartment 150 is formed by the sides 96, 98, the bottom 90 and the mid level divider 110. The rear will either be a stiffener 152 comparable to stiffener 126 or the rear 94. The third enclosure 150 also has a face portion 153 that is part of face 100 with an aperture 154 formed therein. The third compartment 150 is sized to receive a speaker such as a large sub bass speaker 38 that is larger than 10 inches in diameter (e.g., aperture 150) and preferably about 18 inches in diameter.

It should also be noted that the speakers in the speaker groups 26, 28 and speaker 38 are preferably of the type in which the magnet associated therewith is made of neodymium. Such speakers are substantially lighter than speakers using ferrous metals. In turn the speaker system 20 configured generally as shown in FIG. 2 is lighter and can be 30-40 pounds lighter than a speaker system configured comparably but using speakers made with ferrous magnets.

With each of the three compartments 102, 122 and 150 acoustically isolated and preferably hermetically sealed from each other, the sound emanating from each compartment is believed to be cleaner and sharper. That is, vibrations from the speakers in one compartment are not transmitted to and impressed or imposed on a speaker in another compartment. Thus, the acoustical clarity or purity of sound generated by each speaker is higher. The sound generated is that intended to be generated and not some variation dampened or varied by sound reflected from other speakers. In turn, the sound from each separate speaker has also been found to have a relatively flat response curve. That is, the sound produced at a particular level or volume is fairly flat or even across the desired frequency range and particularly the bass range from around 25 Hz to about 10 kHz. It has also been found that positioning speakers in separate enclosures for particular frequency ranges also yields better or improved transient response.

FIG. 2A is a perspective exploded view of a lower portion 29 of a chassis 22A including a fourth compartment 190 for use with the sound generating system of the present invention. The lower portion 29 of chassis 22A is drawn to include the third compartment 150A and enclosure 195, where enclosure 195 includes the fourth compartment 190. More particularly, lower portion 29 may be substituted for the third compartment 150 in FIG. 2, such that lower portion 29 is combined with the first compartment 102 and second compartment 122 of chassis 22 to form the speaker system 20 in FIG. 2 of the present invention. FIG. 2A is viewed from a perspective taken from the rear of the chassis 22A, such that the rear 94A is presented in full view.

As shown in FIG. 2A, third compartment 150A is formed by the sides 96A, 98A, the bottom 90A, and mid level divider 110A. Also, the rear of the third compartment 150A will either be stiffener 152A or divider board 197. Stiffener 198 is included with stiffener 152A for further internal stability. The third compartment 150A also has a face portion 153A that is part of a face (e.g., face 100 of FIG. 2) of a speaker system with an aperture 154A formed therein. The third enclosure 150A is sized to receive a speaker, such as a large sub bass speaker 38 that is larger than 10 inches in diameter and preferably about 18 inches in diameter. Importantly, the third compartment 150A is acoustically isolated and preferably hermetically sealed from the other compartments (e.g., first compartment 102 and second compartment 122) in order to reduce the vibrations generated within one compartment from affecting, transmitting to, or imposing on a speaker in another compartment. As such, the acoustical clarity or purity of sound generated by each speaker in each of the compartments is higher or better because it is believed that it does not pick up or is not vibrated by the sound energy emanating from the other speakers in the other compartments 102 and 122

In FIG. 2A, enclosure 195 is formed by the sides 96A, 98A, bottom 90A, mid level divider 110A, and rear 94A. In some implementations, enclosure 195 is sealed from the other compartments (e.g., first compartment 102, second compartment 122, and third compartment 150A). In addition, rear 94A includes a rear hatch 191 that provides access into enclosure 195. In other cases, enclosure 195 is not sealed, in which case divider 197 may include open spaces to reduce the weight of the chassis 22A.

Rear hatch 191 includes a fourth compartment 190 that is a power amplifier box, and that is sized to receive one or more power amplifiers (e.g., power amplifiers 60, 62, and 64 of speaker system 20) to boost the signal going to the speakers in the other acoustic compartments (e.g., first compartment 102, second compartment 122, and third compartment 150A). In one implementation, the power amplifiers are mounted onto a metal chassis and placed into the fourth compartment 190. The fourth compartment is formed by the sides 181, 182, 183, and 184. Also, the fourth compartment 190 is formed by the rear face 185. Suitable openings are made in the fourth compartment 190 to provide for wiring and controls. Rear panel 94A and hatch 191 are shown cut-away to more fully expose the fourth compartment 190. In addition, the exposed edges of the four sides 181-184 outlining the front 186 of the fourth compartment 190 are further mounted against the inside of the rear hatch 191, thereby forming a sealed compartment for the power amplifiers. When the rear hatch 191 is installed to rear panel 94A, the rear 185 of the fourth compartment butts up against the divider board 197, which has been recessed to allow the fourth compartment to enter into the lower portion 29 of chassis 22A. As shown in FIG. 2A, rear hatch 191 may include fan vents 192 to provide a cooling paths into and out of the fourth compartment 190 in order to provide an optimal environment for the power amplifiers contained therein. Importantly, even with fan vents 192 exposed to the outside environment, the fourth compartment 190 is sealed from the other compartments (e.g., first compartment 102, second compartment 122, third compartment 150A, and enclosure 195).

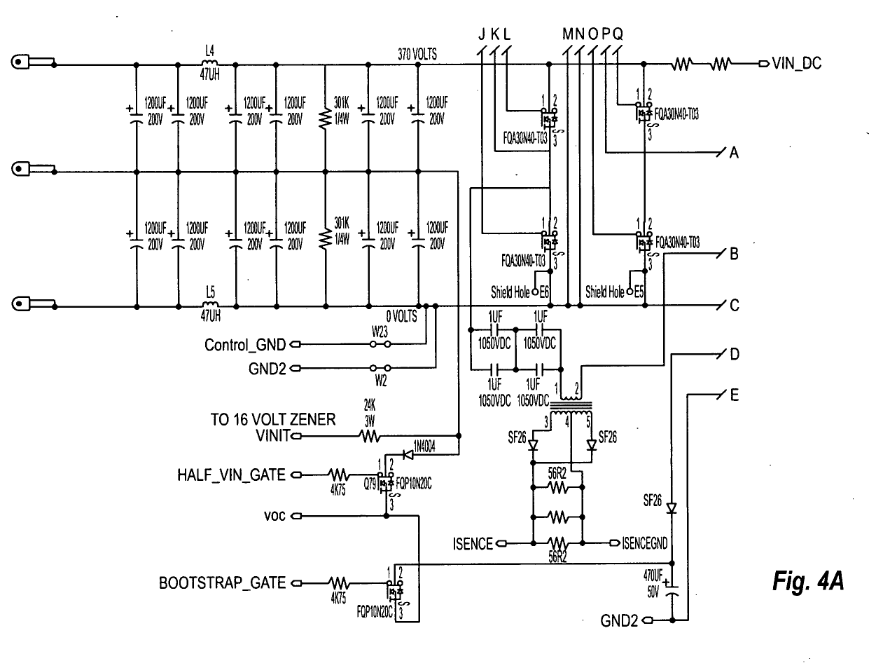

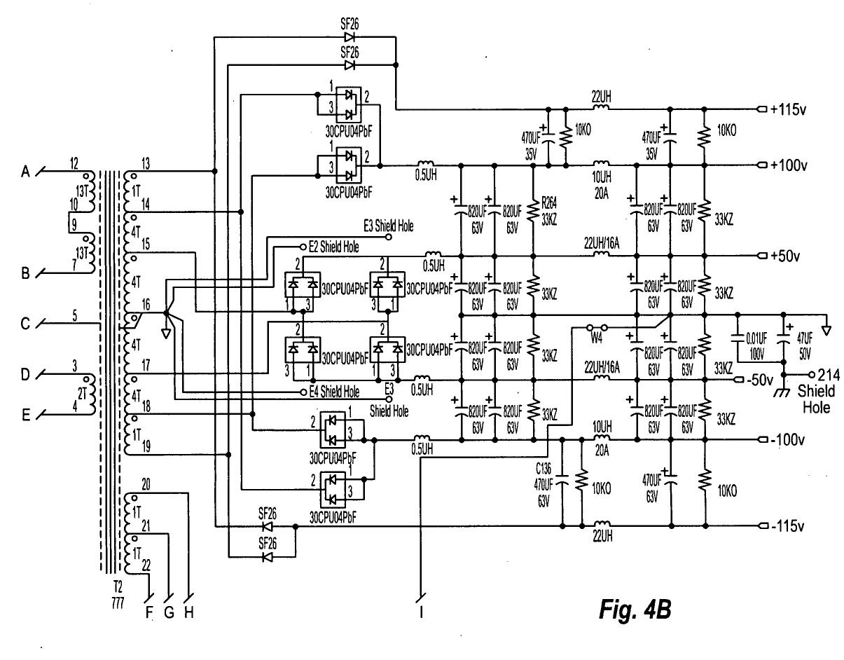

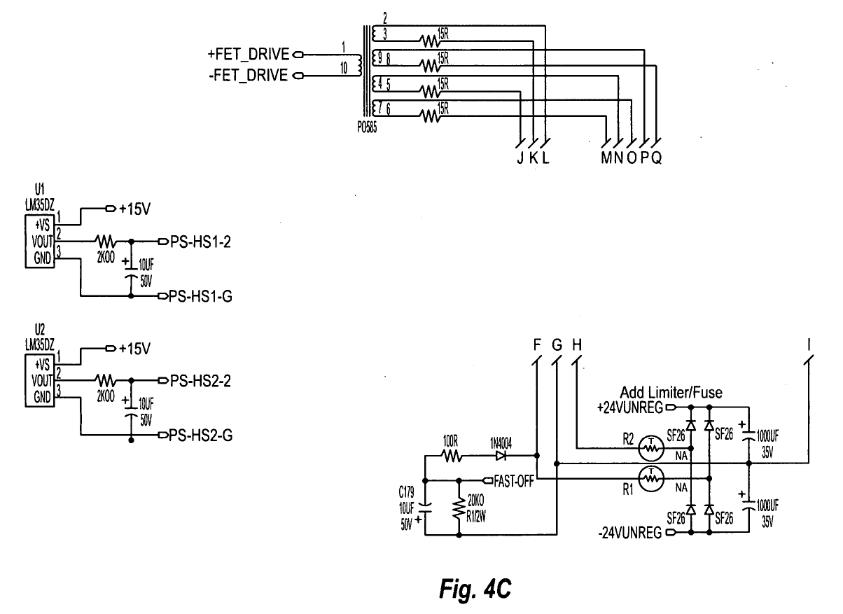

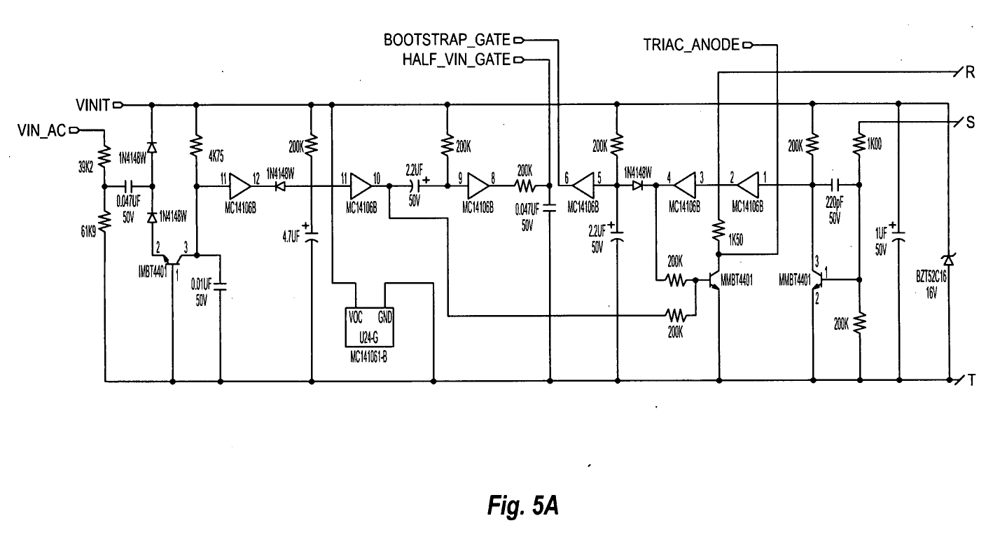

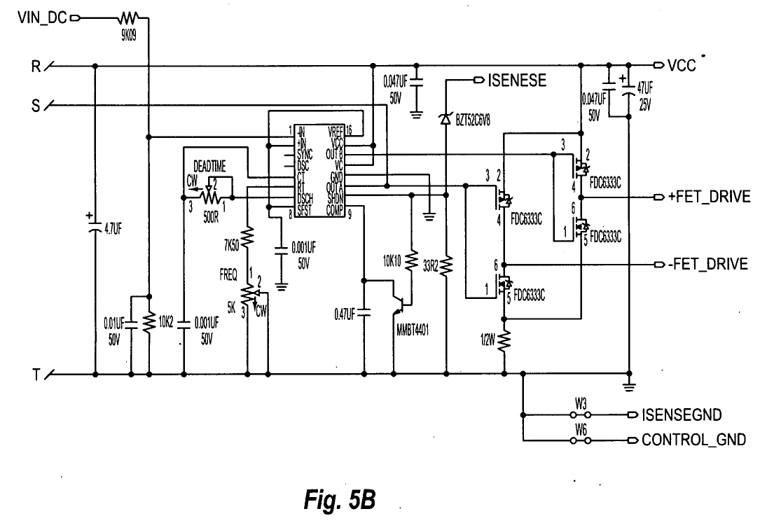

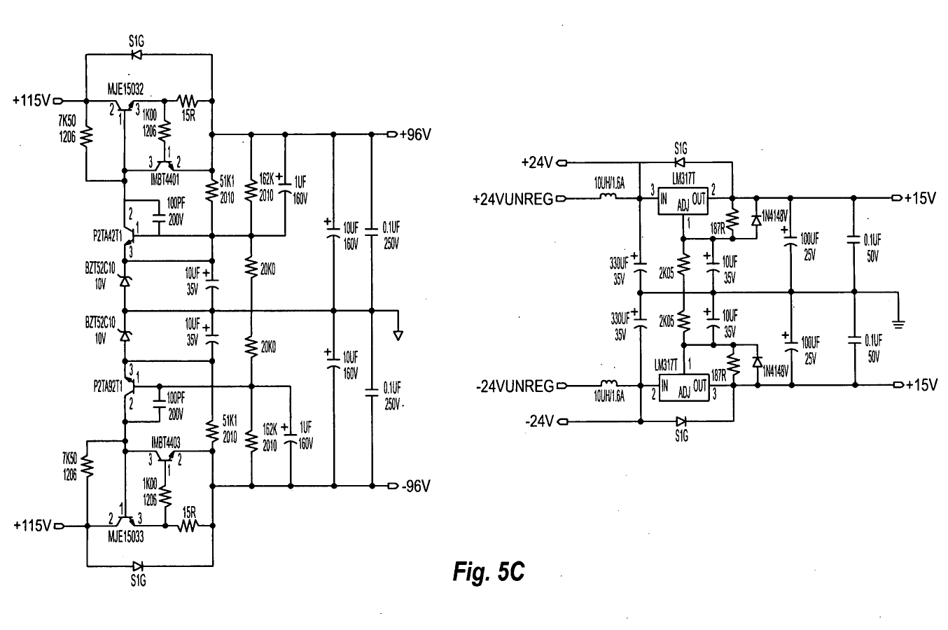

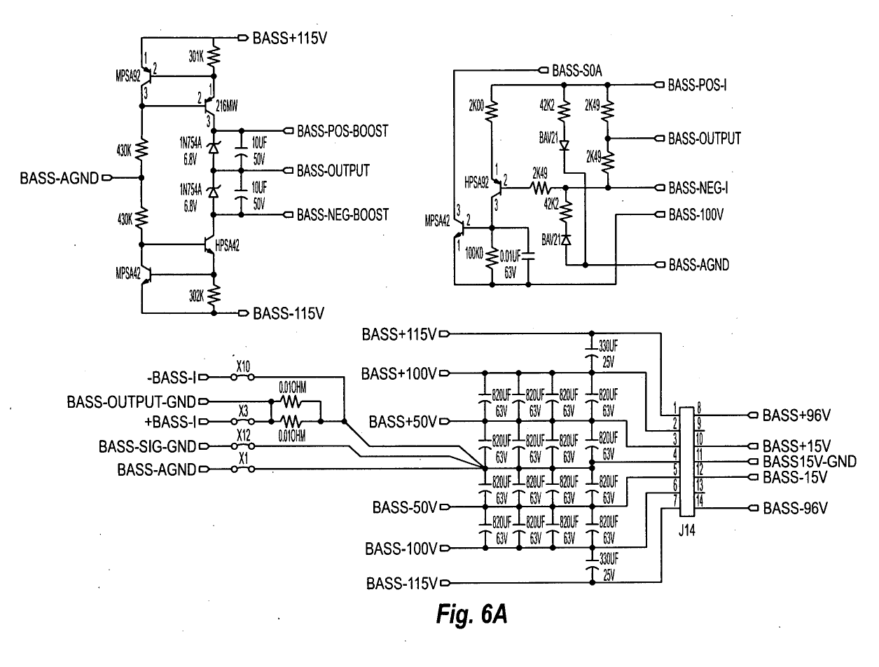

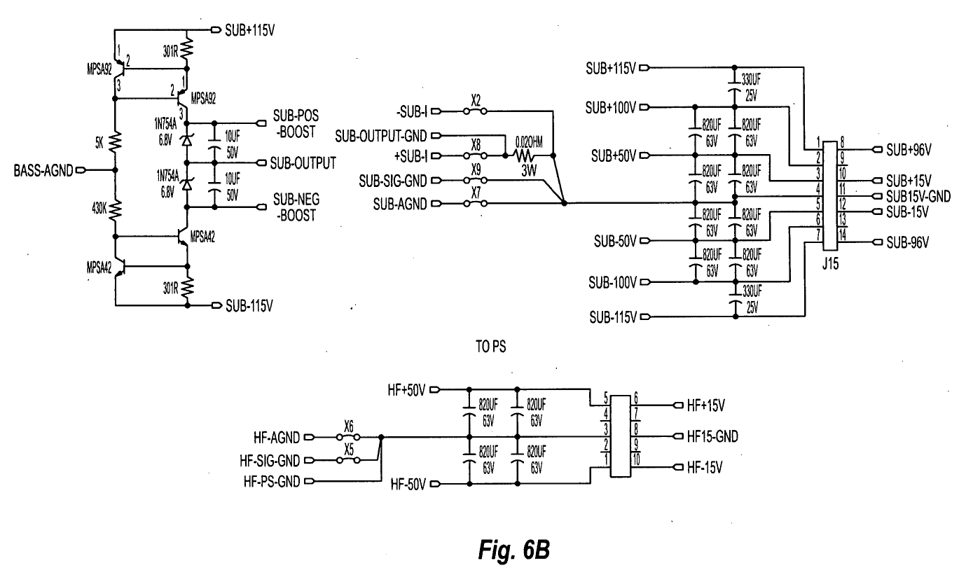

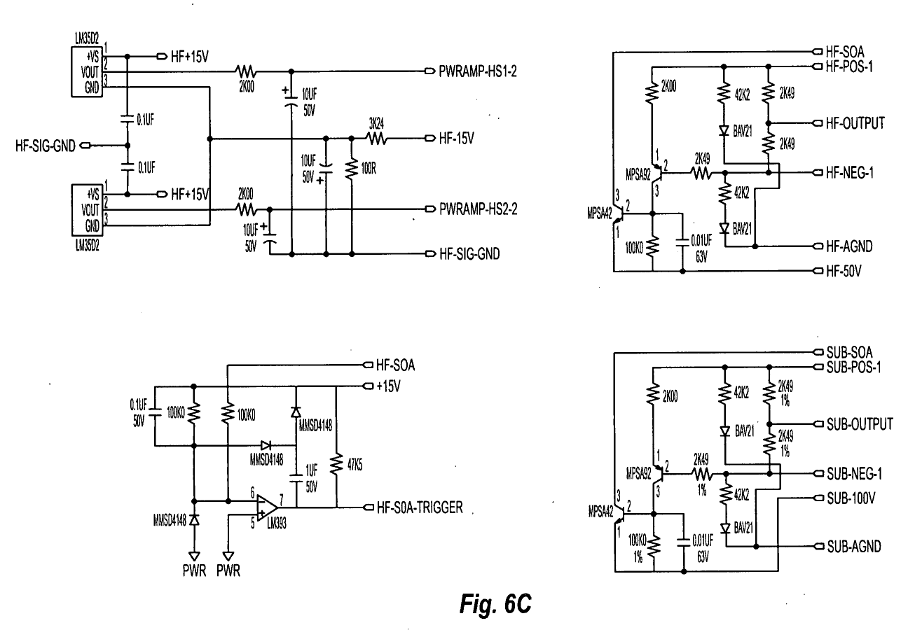

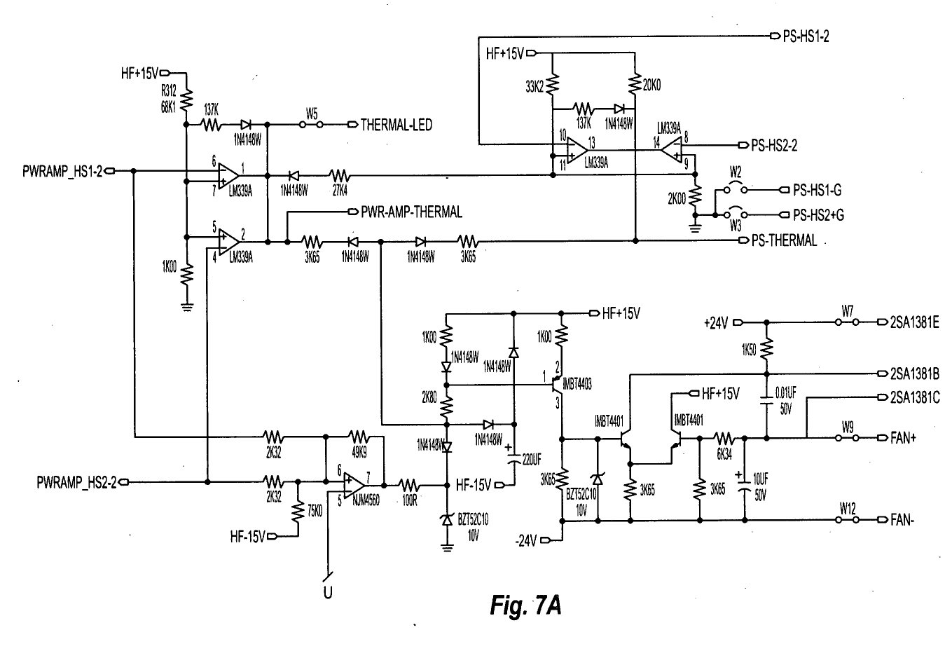

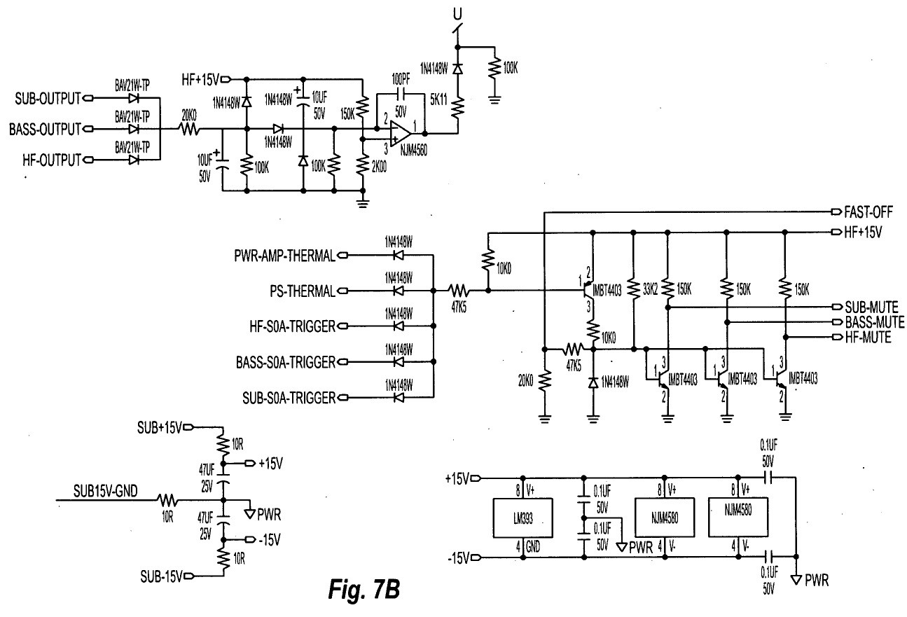

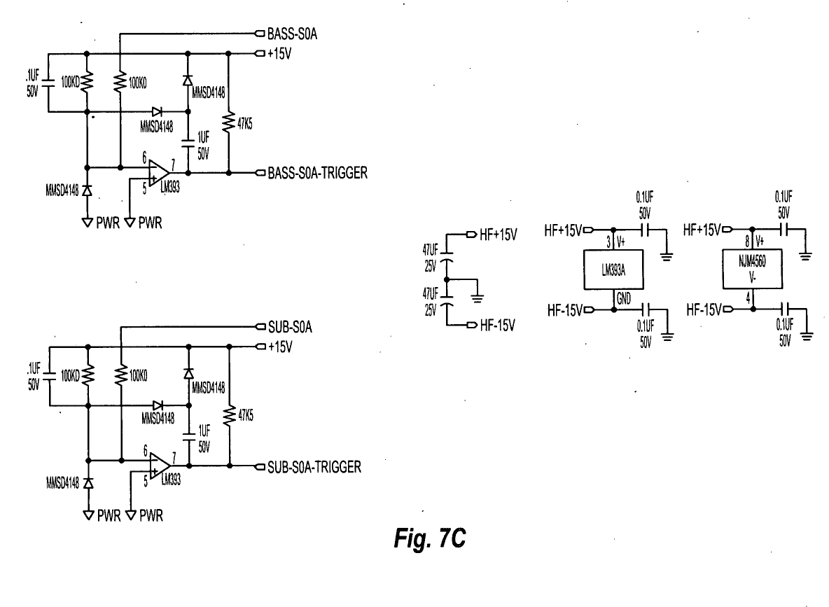

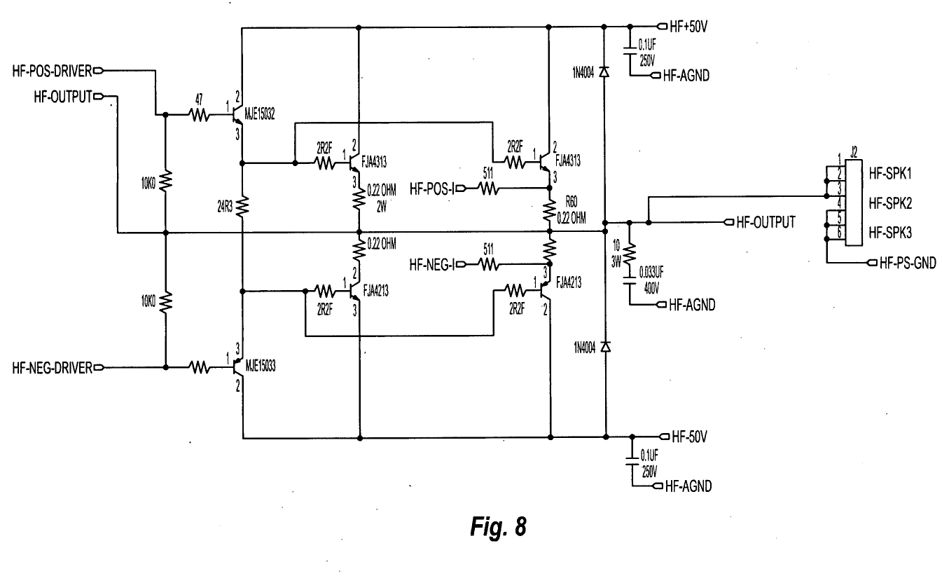

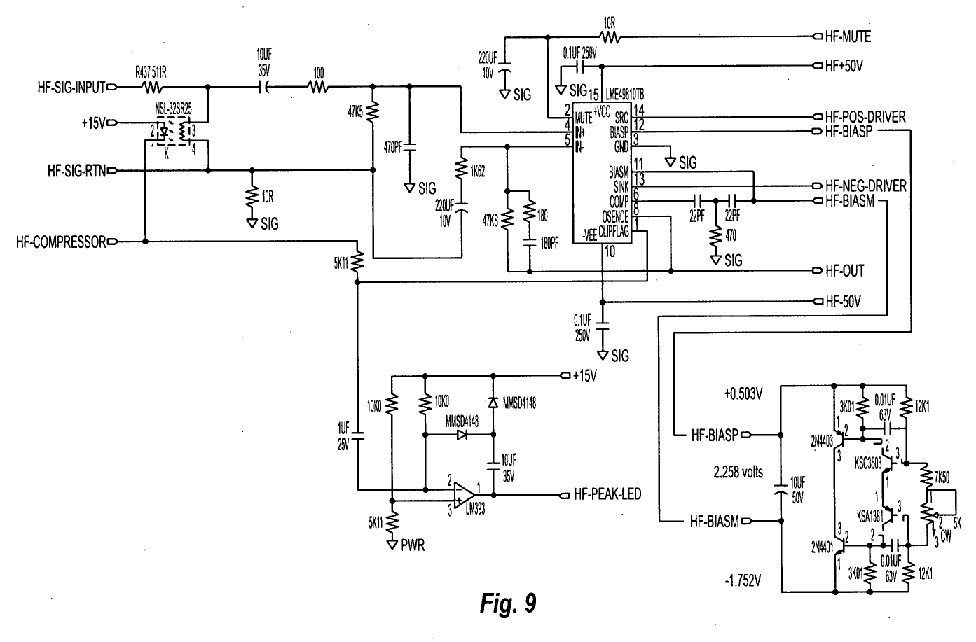

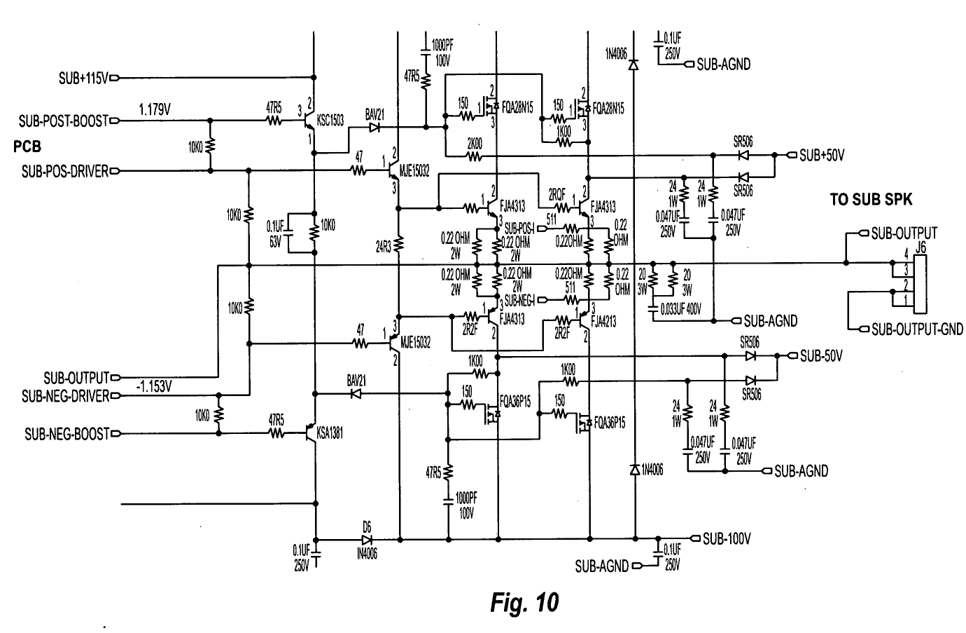

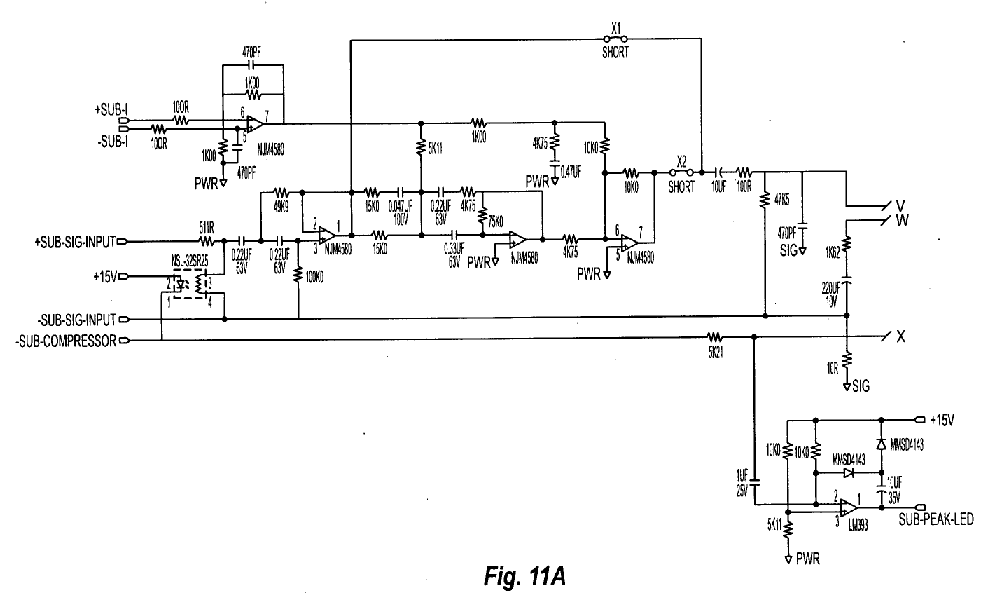

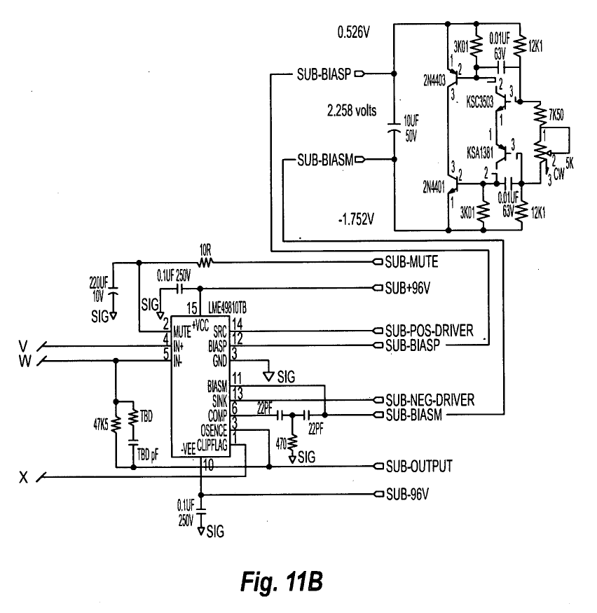

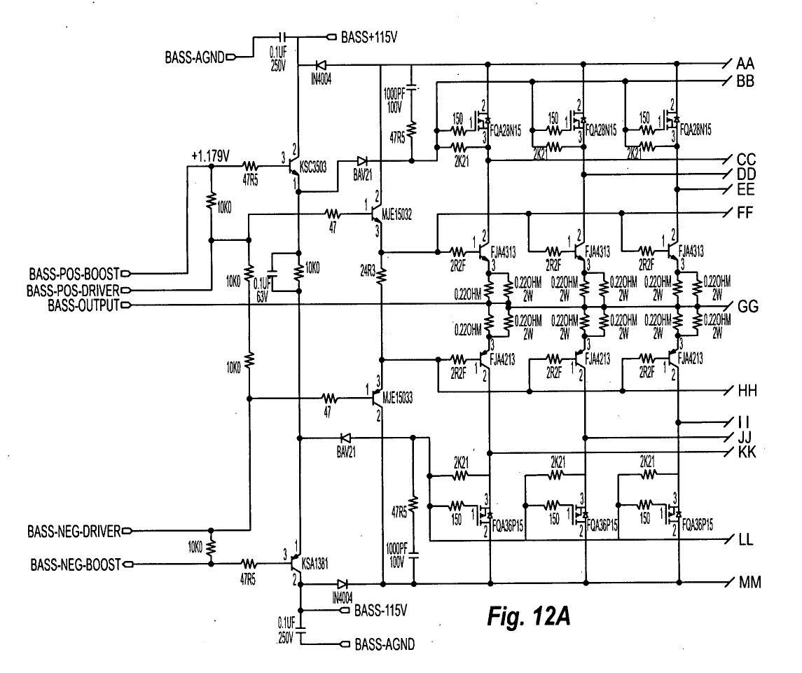

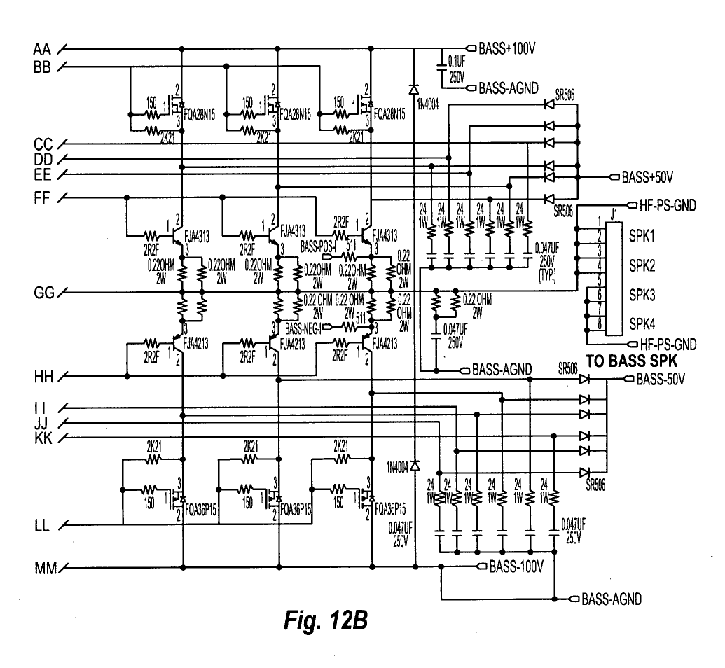

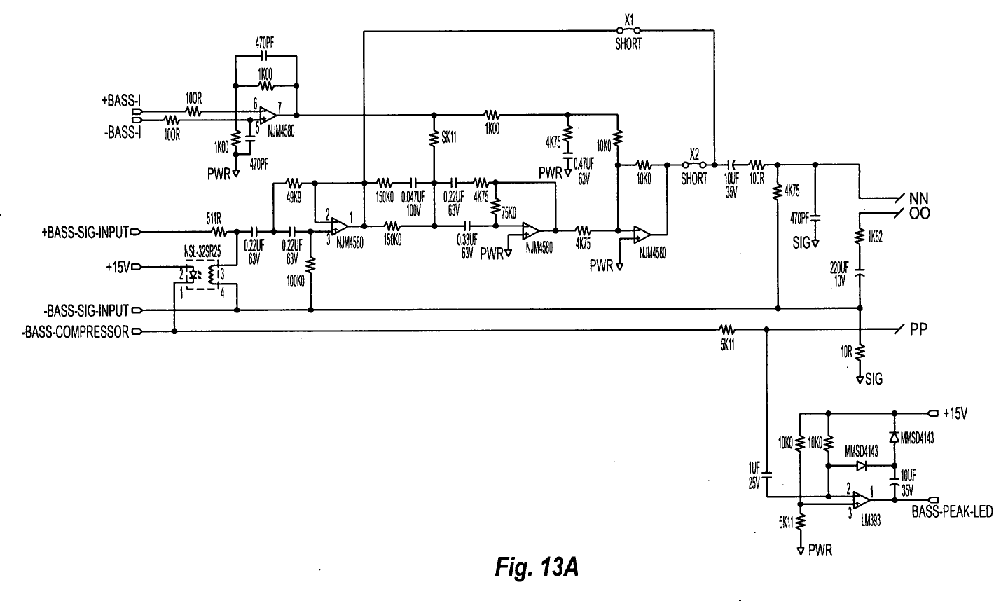

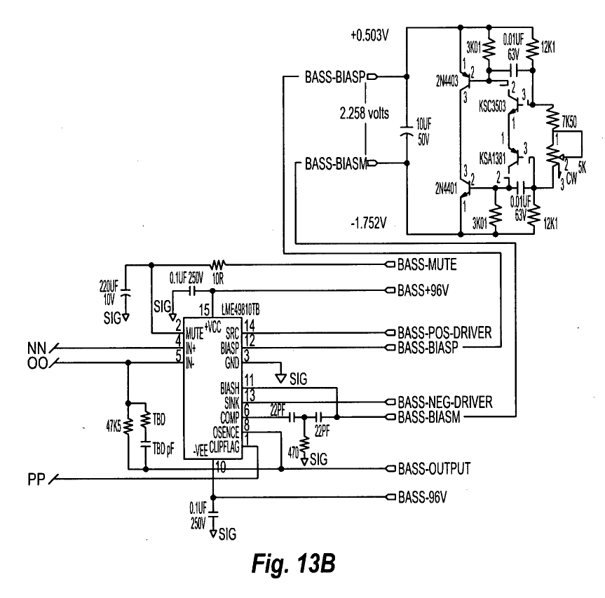

Turning now to FIGS. 3-13, each discloses circuits that are useful for the identified component of amplifier 24. FIG. 3 illustrates a circuit that can be used as a suitable line filter, such as an RFI filter. FIGS. 4 and 5 illustrate circuitry for use as a suitable power supply. FIGS. 6 and 7 show circuitry for interconnection with other components that are useful to handle house keeping functions and control functions including interfacing functions. FIGS. 8, 10 and 12 are circuit diagrams for power amplifiers suitable for use with the sound system of the present invention for amplification in each of the three frequency ranges here involved (HF, bass and sub bass). FIGS. 9, 11 and 13 are circuit diagrams of driver circuits suitable for use with their respective power amplifiers. Notably the circuits illustrated contain values for components or component codes. The values are expressed in a more recent convention so that, for example 3K1 means 3100 ohms.

Also many units are expressed as micro units (10⁻⁶) which is traditionally shown using a Greek letter μ. However, in FIGS. 3-13, the micro units are shown using the letter “u”. It may also be noted that the speaker system here disclosed is particularly useful or suitable for use with a bass guitar. Variations for use with other guitars and other instruments are contemplated. That is, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A speaker system comprising:
a chassis having a face, a first compartment having a first side that is a portion of said face and a second compartment having a second side that is a portion of said face, said second compartment being acoustically isolated from said first compartment;
a first speaker for transmitting sound in a first frequency range, said first speaker being positioned in said first compartment and mounted to transmit sound through a first aperture formed in said first side; and
a second speaker for transmitting sound in a second frequency range different from said first frequency range, said second speaker being positioned in said second compartment and mounted to transmit sound through a second aperture formed in said second side.

2. The speaker system of claim 1 further including an amplifier positioned in said chassis for connection to an external source of an electrical signal reflective of a desired sound, said amplifier being coupled to supply signals to said first speaker to cause said first speaker to transmit sound in said first frequency range and to supply signals to said second speaker to cause said second speaker to transmit sound in said second frequency range.

3. The speaker system of claim 2 wherein said chassis includes a top and bottom, and side means assembled with said face to define an interior containing said first compartment and said second compartment.

4. The speaker system of claim 3 wherein said chassis includes a third compartment acoustically isolated from said first compartment and said second compartment, and where said speaker system further includes a third speaker for transmitting sound in a third frequency range different from said first frequency range and said second frequency range, said third speaker being positioned in said third compartment and mounted to transmit sound through a third aperture formed in said first side.

5. The speaker system of claim 4 wherein said third compartment is positioned within one of said first compartment and said second compartment.

6. The speaker system of claim 5 wherein said third frequency range is a bass frequency range, wherein said second frequency range is a mid range frequency and wherein said first frequency range is the HF frequency range.

7. A speaker system comprising:
a chassis;
a first compartment formed as part of said chassis, said first compartment having a first face oriented outwardly from said chassis, said first face having a first aperture formed therein sized to receive a first speaker therein oriented to transmit sound away from said chassis;
a second compartment formed as part of said chassis, said second compartment having a second face oriented outwardly from said chassis, said second face having a second aperture formed therein sized to receive a second speaker therein oriented to transmit sound away from said chassis; said second compartment being configured to be acoustically isolated from said first compartment.

8. The speaker system of claim 7 further including a third compartment formed as part of said chassis, said third compartment having a third face oriented outwardly from said chassis, said third face having a third aperture formed therein sized to receive a third speaker therein oriented to transmit sound away from said chassis; said third compartment being configured to be acoustically isolated from said first compartment and said second compartment.

9. The speaker system of claim 8 wherein said chassis has a speaker side, and wherein said first side of said first compartment, said second side of said second compartment, and said third side of said third compartment are each part of said speaker side of said chassis.

10. The speaker system of claim 9 further including said first speaker operable to transmit sound at a first frequency range, said first speaker being positioned in said first compartment and oriented to transmit sound through said first aperture, said second speaker operable to transmit sound at a second frequency range different from said first frequency range, said second speaker being positioned in said second compartment and oriented to transmit sound through said second aperture; and said third speaker operable to transmit sound at a third frequency range different from said first frequency range and said second frequency range, said third speaker being positioned in said third compartment and oriented to transmit sound through said third aperture.

11. The speaker system of claim 10 wherein said first compartment is positioned within said second compartment.

12. The speaker system of claim 11 wherein said first speaker is a high frequency (HF) speaker, wherein said second speaker is a mid range speaker, and said third speaker is a bass speaker.

13. The speaker system of claim 10 wherein said first speaker is circular in projection and less than about 6 inches in diameter, wherein said second speaker is circular in projection and less than about 10 inches in diameter and wherein said third speaker is circular in projection and more than about 10 inches in diameter.

14. The speaker system of claim 8 wherein said first compartment has a top, a bottom and at least one side all assembled to be hermetically sealed separate from and within said second chamber.

15. The speaker system of claim 14 wherein said second chamber and said third chamber are each enclosed and wherein said second chamber and said third chamber have a common side.

16. The speaker system of claim 14 wherein said first chamber, said second chamber and said third chamber are each assembled in said chassis to be hermetically sealed from each other.

17. A speaker system comprising:
a chassis;
a first compartment formed as part of said chassis, said first compartment having a first face oriented outwardly from said chassis, said first face having a first aperture formed therein sized to receive a first speaker therein oriented to transmit sound away from said chassis;
said first speaker positioned in said first compartment and oriented to transmit sound through said first aperture away from said chassis;
a second compartment formed as part of said chassis, said second compartment having a second face oriented outwardly from said chassis, said second face having a second aperture formed therein sized to receive a second speaker therein oriented to transmit sound away from said chassis; said second compartment being acoustically isolated from said first compartment; and
said second speaker positioned in said second compartment and oriented to transmit sound through said second aperture away from said chassis;

18. A speaker system comprising:
a chassis having at least one side;
a first compartment formed as part of said chassis, said first compartment having a first face oriented outwardly from said chassis and part of said one side, said first face having a plurality of first apertures formed therein each sized to receive one of a corresponding plurality of first speakers, each of said first speakers being oriented to transmit sound through its corresponding first aperture;
a second compartment formed as part of said chassis, said second compartment having a second face oriented outwardly from said chassis and part of said one side, said second face having a plurality of second apertures formed therein each sized to receive one of a corresponding plurality of second speakers therein, each of said second speakers being oriented to transmit through its corresponding second aperture, said second compartment being configured to be acoustically isolated from said first compartment;
a third compartment formed as part of said chassis, said third compartment having a third face oriented outwardly from said chassis and part of said one side, said third face having a third aperture formed therein sized to receive a third speaker therein oriented to transmit sound through said third aperture, said third compartment being configured to be acoustically isolated from said first compartment and said second compartment;
said plurality of first speakers each for positioning in said first compartment to transmit sound through one of said plurality of first apertures, said first speakers each being operable to transmit sound at a first frequency range;
said plurality of second speakers each for positioning in said second compartment to transmit sound through one of said plurality of second apertures at a second frequency range different from said first frequency range; and
said third speaker operable to transmit sound at a third frequency range different from said first frequency range and said second frequency range, said third speaker being positioned in said third compartment to transmit sound through said third aperture.

19. A sound producing system comprising:
a sound generator configured to be operated by a user to supply electrical signals reflective of a desired sound; and
a speaker system having
a chassis with a first side;
a first compartment formed as part of said chassis, said first compartment having a first face oriented outwardly from said chassis and part of said first side, said first face having at least one first aperture formed therein sized to register with a first speaker positioned to transmit sound through said first aperture;
a second compartment formed as part of said chassis, said second compartment having a second face oriented outwardly from said chassis and part of said first side, said second face having at least one second aperture formed therein sized to register with a second speaker positioned to transmit sound there through, said second compartment being configured to be acoustically isolated from said first compartment;
said first speaker sized for positioning in said first compartment to transmit sound through said first aperture in said first face, said first speaker being operable to transmit sound at a first frequency range;
said second speaker for positioning in said second compartment to transmit sound through said second aperture in said second face, said second speaker being operable at a second frequency range different from said first frequency range; and
amplifier means coupled to said sound generator to receive said electrical signals reflective of a desired sound and operable to amplify said electrical signals, said amplifier means being coupled to said first speaker to supply signals to cause said first speaker to transmit sound in said first frequency range, and said amplifier means being coupled to said second speaker to supply signals to cause said second speaker to transmit sound in said second frequency range.

20. The sound system of claim 19 further including
a third compartment formed as part of said chassis, said third compartment having a third face oriented outwardly from said chassis and part of said first side, said third face having a third aperture formed therein sized to register with a third speaker oriented to transmit sound through said third aperture, said third compartment being configured to be acoustically isolated from said first compartment and said second compartment; and
said third speaker operable to transmit sound at a third frequency range different from said first frequency range and said second frequency range, said third speaker being positioned in said third compartment to transmit sound through said third aperture, and said third speaker being coupled to said amplifier means to receive signals to cause said third speaker to transmit sound in said third frequency range.

21. The sound system of claim 20 further including an amplifier compartment separate from said first compartment, said second compartment and said third compartment and sized to receive said amplifier.
